(19) United States
(12) Patent Application Publication
(10) Pub. No.: US 2014/0012793 A1
(43) Pub. Date: Jan. 9, 2014

(54) SYSTEM AND METHOD FOR PREDICTING SURGERY PROGRESS STAGE

(71) Applicants: Myon Woong Park, Seoul (KR); Gyu Hyun Kwon, Seoul (KR); Young Tae Sohn, Seoul (KR); Jae Kwan Kim, Seoul (KR); Hyun Chul Park, Busan (KR)

(72) Inventors: Myon Woong Park, Seoul (KR); Gyu Hyun Kwon, Seoul (KR); Young Tae Sohn, Seoul (KR); Jae Kwan Kim, Seoul (KR); Hyun Chul Park, Busan (KR)

(73) Assignee: KOREA INSTITUTE OF SCIENCE AND TECHNOLOGY, Seoul (KR)

(21) Appl. No.: 13/749,073

(22) Filed: Jan. 24, 2013

(30) Foreign Application Priority Data
Jul. 3, 2012 (KR) 10-2012-0072420

(51) Int. Cl. G06N 5/02

(52) U.S. Cl. CPC G06N 5/02
USPC 706/46

(57) ABSTRACT

System and method for predicting a surgery progress stage according to the present disclosure sense a surgery motion pattern according to a surgery motion, store surgery stage information according to the kind of surgery and pattern information of major surgery motions of each surgery stage, determine a present surgery motion pattern corresponding to the sensed surgery motion pattern from the surgery motion pattern information stored in the data storing unit, and predict a surgery stage corresponding to the determined present surgery motion pattern based on the surgery stage information stored in the data storing unit.

### CROSS-REFERENCE TO RELATED APPLICATION

This application claims priority to Korean Patent Application No. 10-2012-0072420, filed on Jul. 3, 2012, and all the benefits accruing therefrom under 35 U.S.C. §119, the contents of which in its entirety are herein incorporated by reference.

### BACKGROUND

1. Field

The present disclosure relates to context awareness, and more particularly, to system and method for predicting a situation and a trend of each surgery stage based on a knowledge model and various object recognition techniques.

2. Description of Related Art

Under a complicated environment of a surgical operating room where many persons participating in the surgery and various instruments are present, it is not easy to exactly understand a surgery progress stage. An operating surgeon is generally aware of overall situations about the surgery, but it is difficult and inconvenient to periodically share the present progresses with other persons participating in the surgery while performing the surgery, which results in inefficient surgery. Accordingly, system and method for allowing persons participating in a surgery to recognize present surgery progresses are needed.

In order to recognize surgery progresses, the overall surgery procedure should be understood, and a present situation should be figure out. Therefore, the present situation may be recognized under a pressing surgery environment only when general progress stages for each kind of surgery should be recognized and various irregular events which may occur at each stage should be defined in advance. Generally, in a knowledge modeling method, a relation with an object is defined, and the corresponding relation is inferred to construct Ontology which allows a system to interpret the knowledge.

### SUMMARY

The present disclosure is directed to providing a method for allowing surgery stages, which may be performed according to the kind of surgery, and various surgery situations, which may occur during the surgery, to be defined and also allowing each stage to be recognized by a mechanical apparatus.

In one aspect, there is provided a system for predicting a surgery progress stage, which includes: a surgery motion sensing unit for sensing a surgery motion pattern; a data storing unit for storing surgery stage information according to the kind of surgery and motion pattern information about principle major surgery motions of each surgery stage; a surgery motion pattern determining unit for determining a present surgery motion pattern corresponding to the sensed surgery motion pattern, from the motion pattern information stored in the data storing unit; and a surgery stage predicting unit for predicting a surgery stage corresponding to the determined present surgery motion pattern, based on the surgery stage information stored in the data storing unit. The surgery motion pattern may be a hand motion pattern and/or a motion pattern of a surgical instrument. The surgery motion sensing unit may include: a sensor for sensing a surgery motion image; and a data converting unit for patterning the sensed surgery motion image to be converted into a predefined data format. The surgery motion pattern determining unit may include a sub-pattern determining unit for storing a surgery motion pattern of a previous stage in the data storing unit and determining the present surgery motion pattern, based on the stored surgery motion pattern of the previous stage. The system for predicting a surgery progress stage may further include a surgery stage display unit for displaying the predicted surgery stage to be provided to a user.

In another aspect, there is provided a method for predicting a surgery progress stage, which includes: sensing a surgery motion pattern; determining a present surgery motion pattern corresponding to the sensed surgery motion pattern, from major surgery motion pattern information stored in advance; and predicting a surgery stage corresponding to the determined present surgery motion pattern, based on surgery stage information according to the kind of surgery stored in advance. The surgery motion pattern may be a hand motion pattern and/or a motion pattern of a surgical instrument. The sensing of a surgery motion pattern may include: sensing a surgery motion; and patterning the sensed surgery motion to be converted into a predefined data format. The method for predicting a surgery progress stage may further include storing surgery motion patterns of a previous stage and a present stage in a database, wherein the determining of a present surgery motion pattern may include determining the present surgery motion pattern among the major surgery motion pattern information, based on the stored surgery motion pattern of the previous stage and the surgery stage information according to the kind of surgery stored in advance. The method for predicting a surgery progress stage may further include providing the predicted surgery stage to be provided to a user by using a display device or a sound device.

According to an aspect of the present disclosure, all persons participating in a surgery as well as an operating surgeon may recognize a present surgery progress stage by displaying a present surgery procedure. By doing so, each person participating in the surgery may know a task performed presently and prepare a task to be performed in the future in advance. In addition, an estimated surgery termination time may be determined, and a surgery schedule may be more efficiently managed to reduce the vacancy of operating rooms. Since a guardian of a patient as well as the persons concerned in the surgery may know a surgery progress procedure and an estimated surgery termination time, the guardian may conveniently cope with the surgery progresses and may feel less nervous.

Moreover, in the case where a task other than the set surgery progress stage is performed while monitoring a surgery procedure, this may be informed to prevent the operating surgeon from making a mistake. In other words, a medical accident, for example caused by suturing without removing a surgical instrument, may be prevented. In addition, by providing a surgery progress guideline, an operating surgeon may perform a surgery without a mistake by referring to the guideline, and caution information at the present may be actively provided by a system. Furthermore, through a standardizing process for the surgery progress procedure, an operating procedure may be expressed in a systematic format. This information may be used for reviewing and evaluating a surgery procedure after performing a surgery, and also as basic data for education for surgery.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a block diagram showing a surgery stage predicting system 100 according to an embodiment of the present disclosure;

FIG. 2 is a block diagram showing a surgery motion sensing unit 110 according to an embodiment of the present disclosure;

FIG. 3 is a block diagram showing a data storing unit 120 according to an embodiment of the present disclosure; and

FIG. 4 is a flowchart for illustrating a method for predicting a surgery stage according to an embodiment of the present disclosure.

### DETAILED DESCRIPTION

Hereinafter, embodiments of the present disclosure will be described in detail with reference to the accompanying drawings.

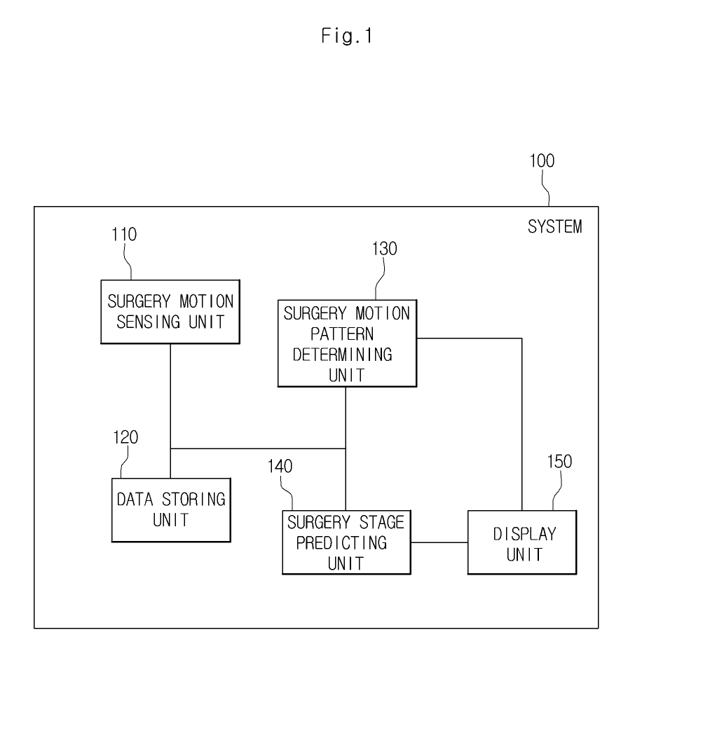

FIG. 1 is a block diagram showing a surgery stage predicting system 100 according to an embodiment of the present disclosure.

Referring to FIG. 1, the surgery stage predicting system 100 according to an embodiment of the present disclosure includes a surgery motion sensing unit 110 for sensing a surgery motion (for example, a hand motion and/or a motion of a surgical instrument) of an operating surgeon, a data storing unit 120 for storing necessary data for predicting a surgery stage in advance and storing temporary data, a surgery motion pattern determining unit 130 for determining a surgery motion pattern of the operating surgeon, a surgery stage predicting unit 140 for predicting a present surgery stage, and a surgery stage display unit 150 for displaying the present surgery stage and the present surgery motion to a user.

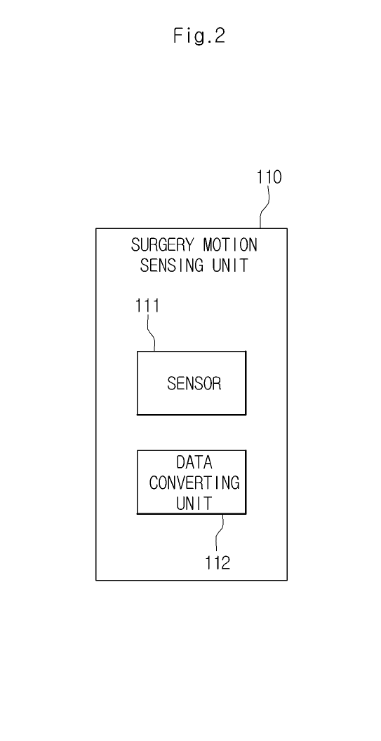

Referring to FIG. 2, the surgery motion sensing unit 110 according to an embodiment of the present disclosure may include a sensor 111 and a data converting unit 112 for patterning the information obtained by the sensing unit and transferring the corresponding information to the surgery motion pattern determining unit 130. The surgery motion sensing unit 110 may collect three-dimensional motion data about surgery motions of the operating surgeon by using the sensor, and the data converting unit 112 may pattern the sensed surgery motion (wherein the surgery motions, a specific motion is classified into motion units) and provide the data to the determining unit 130 in a predetermined information format to be compared with the stored surgery motion pattern.

For example, a hand motion of the operating surgeon for packing a scalpel and incising the abdomen is stored as a single pattern, and this may include recognizable vision information and sensor information. In another case, in the case where the operating surgeon incises the abdomen of a patient, the hand motion of the operating surgeon may be expressed as a pattern with predetermined height, speed and direction. At this time, by using a sensor (for example, a camera), the speed, direction and location of a moving hand, the movement of a finger or the like may be collected as data corresponding to the hand motion of the operating surgeon. In addition, pattern information may be generated based on the collected data.

In an embodiment, the hand motion of the operating surgeon described above is just an example, and the target to be sensed may include behaviors of persons participating in the surgery and motions of surgical instruments, in addition to the hand motion of the operating surgeon. For example, when signals sent from an acceleration sensor, a geometric sensor and a pressure sensor attached to a hemostat (a surgical instrument required for hemostasis) may be sensed, if the corresponding signals are fixed at a certain location, the situation utilized for hemostasis may be recognized.

In an embodiment, the recognition ratio for the surgery motion may be enhanced by sensing both the hand motion of the operating surgeon and the motion of the surgical instrument. In addition, the recognition ratio for a present surgery motion may be enhanced depending on the kind of a surgical instrument used for the surgery motion, a location of the surgical instrument prepared in the surgery procedure, the use of the surgical instrument or the like. For example, in the case where the operating surgeon makes a motion while gripping a Mosquito, a motion pattern which may be performed simultaneously with or subsequently from the hemostasis of the blood vessel may be predicted to enhance a recognition ratio. Similarly, in case of using a Mayo scissors, it may be recognized that a thick tissue is cut. Therefore, the recognition ratio may be enhanced by adding the motion of a surgical instrument.

As the sensing unit according to an embodiment of the present disclosure, various sensors may be used to sense a surgery motion of the operating surgeon. The sensor may be either a contact-type or non-contact-type sensor. In detail, in the contact-type method, in a state where a sensor is attached to the human body, location, rotating or movement information of the contact sensor is received to trace a motion.

As a representative example, an optical motion tracker (which traces a motion of a marker in a three-dimensional space according to a body motion in a state of attaching the marker to the human body to be traced), an acceleration sensor (which traces a motion by outputting an acceleration value of a portion of a human body according to a motion in a state of attaching the sensor to the human body), a pressure sensor, an IMU sensor (which outputs the degree of rotation of a human portion to which the sensor is attached) or the like may be used. In the non-contact method, without adhering or contacting a sensor or other substance to a human body, a body motion is traced by using a camera (a vision sensor, a CCD or the like). By using a plurality of cameras installed at various angles, a surgery motion may be photographed and recognized from various angles, and a user may not feel the sense of difference and make a free motion as usual.

In the sensing method of the motion sensing unit according to an embodiment, a hand motion of the operating surgeon may also be recognized through distance information obtained by using a three-dimensional camera. In other words, a hand region is detected by using three-dimensional distance information. The three-dimensional image input by the camera is converted into a binary image, and then a hand region is roughly searched by means of the noise processing using a light. In addition, the hand region is accurately searched by a filtering process using a mask for each distance. And, a cross product of vectors of the contour of the recognized hand region is obtained, and a fingertip point is detected through direction and angle of the vector of the cross product. In this way, three-dimensional data for the hand motion and the finger motion may be collected.

The sensing unit according to an embodiment of the present disclosure classifies the surgery motion into a regular pattern and compares the regular pattern with the stored data, and so it may be required to classify the surgery motion into a pattern. In detail, the motion pattern may be classified at a certain time interval or based on an instrument used by the operating surgeon.

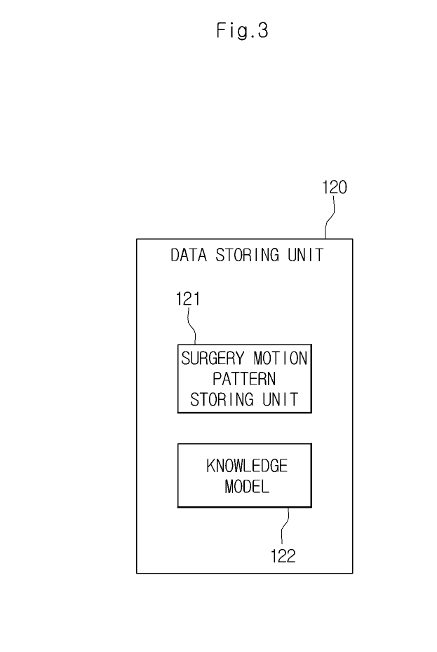

FIG. 3 is a block diagram showing the data storing unit 120 according to an embodiment of the present disclosure. The data storing unit 120 may include a surgery motion pattern storing unit 121 and a surgery procedure knowledge model 122.

In an embodiment, the surgery motion pattern storing unit 121 may store information about a surgery motion pattern of the operating surgeon at each surgery stage according to the kind of surgery. The information stored in the surgery motion pattern storing unit 121 may have a data pattern comparable with the data information collected by the sensing unit and sent to the surgery motion pattern determining unit. In addition, a previous surgery motion pattern may be temporarily or permanently stored to be used as basic data for predicting a present surgery stage.

In an embodiment, the surgery procedure knowledge model 122 may define and store each surgery procedure about various kinds of surgeries. In addition, stages required for a surgery, subordinate surgery tasks required at each stage, and surgery motions required for accomplishing each task may be defined as objects (for example, they may also be defined as a patterned object).

In addition, the surgery procedure knowledge model 122 may include all kind of information, which allows a relation of defined objects to be expressed so that the sequence of objects and preceding/following conditions may be inferred, and defines a start point and a termination point of each surgery stage and task so that a present stage may be easily inferred according to the surgery motion of the operating surgeon.

In addition, according to an embodiment of the present disclosure, the knowledge model may express the knowledge of an operating room domain to be used as basic data for arranging a surgery procedure, persons participating in the surgery, equipment, data or the like, required for the corresponding surgery, and accordingly determining a present stage of the surgery.

The surgery motion pattern determining unit according to an embodiment of the present disclosure may determine a present surgery motion pattern corresponding to the sensed surgery motion pattern, from the surgery motion pattern information stored in the data storing unit. In detail, the surgery motion pattern determining unit compares the hand motion pattern information obtained by the sensing unit with an individual surgery motion pattern already stored in the data storing unit to determine a most similar surgery motion pattern. For example, when the operating surgeon incises the abdomen of a patient, the hand motion has certain height, speed and direction, and accordingly the sensing unit generates motion pattern information. The surgery motion pattern determining unit may determine the stored motion pattern information with the most similar data to the generated motion pattern information as a present motion pattern. Therefore, the determining unit 130 may determine that the operating surgeon is presently performing “abdomen incision”.

In addition, in an embodiment, when determining a present surgery motion pattern, a previous surgery motion pattern may be used. In detail, based on the knowledge model defining the whole surgery procedure, at least one previous surgery motion of the whole surgery procedure may be stored to enhance the recognition ratio when determining a present surgery motion.

For example, in a surgery procedure which is performed in the order of surgery stages A1-B1-C1-D1, if the operation is presently in progress and the stages A1-B1 are already completed, even though surgery motion patterns C1, C2, C3 are determined as a present motion pattern with the same chance, the determining unit 130 may determine the stage C1 as the present surgery motion pattern. Based on the additional information, the process of determining a surgery motion pattern may be executed by a sub-determining unit separately provided or included in the determining unit.

The surgery stage predicting unit 140 according to an embodiment of the present disclosure may predict a surgery stage corresponding to the present surgery motion pattern determined by the determining unit, based on the surgery stage information stored in the data storing unit. In detail, based on the information about surgery progress stages which are different depending on each kind of surgery and frequent probable events which may occur in the operating room, it is possible to predict where the present surgery stage exists in the overall surgery procedure. Generally, the overall surgery procedure includes superordinate stages such as incision, ventrotomy, removal and closure and subordinate stages such as disinfection required for incision, and each subordinate stage is classified into several tens of hand motions again. The surgery stage predicting unit 140 may recognize information about a present surgery situation (a superordinate stage and a subordinate stage) to determine whether an existing surgery stage is completed and a new surgery stage is initiated, and may add surgery motion information newly obtained.

According to an embodiment of the present disclosure, the predicted present surgery stage may be provided to a user by using a display device or a sound device so that the user may recognize the surgery procedure predicted as above. In addition, based on the knowledge model, the information about preparations may be provided to persons participating in the surgery other than the operating surgeon based on the previous and present surgery stages. For example, in the Deep Brain Stimulation (DBS) surgery, if the “brain cell stimulating process” is completed, a surgery participant 1 may be notified to prepare “closure”.

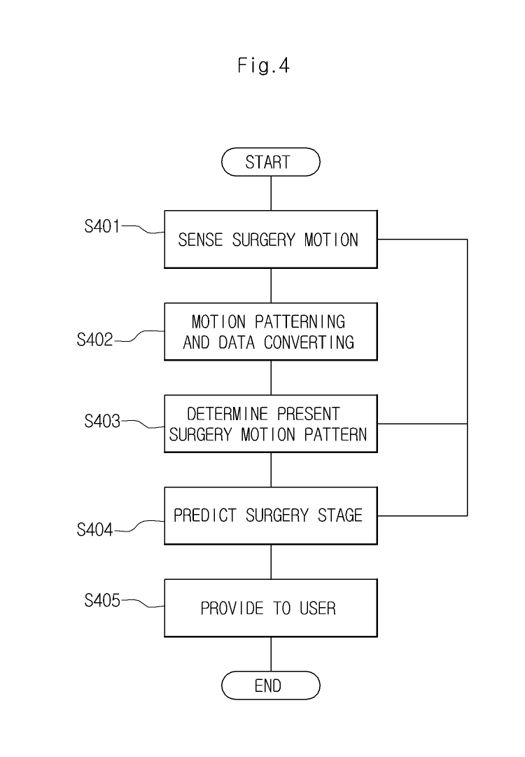

FIG. 4 is a flowchart for illustrating a method for predicting a surgery progress stage according to an embodiment of the present disclosure.

By the user or based on at least one initial motion pattern, expected kinds of surgeries may be determined. In addition, by using a sensor or the like, a surgery motion of the operating surgeon is sensed (S401), and surgery motion data is patterned and collected (S402). The data about the sensed surgery motion is compared with the stored surgery motion patterns to determine a pattern of the present surgery motion (S403). At this time, based on the surgery procedure knowledge model, the present surgery motion pattern may also be determined based on a motion pattern performed at a previous surgery stage. In addition, in the overall surgery procedure, a time point corresponding to the determined motion pattern may be predicted (S404). In this case, based on the knowledge model, a most probable surgery stage (namely, a most probable surgery motion pattern) is preferentially predicted among the corresponding kinds of surgeries to reduce an error. Accordingly, the present surgery stage predicted among the overall surgery procedure may be provided to the user visually or audibly by using a display device or a sound device (S405).

For example, the DBS surgery will be described as an embodiment of the present disclosure. The DBS surgery is generally classified into a state of transplanting an electrode to the brain and a stage of transplanting a device for giving a stimulus to the electrode to the chest portion. The first surgery stage is composed of i) attaching a stereotactic frame, ii) performing MRI or CT scanning, iii) incising the skin and the cranium, iv) inserting an electrode into the brain, v) stimulating brain cells, and vi) closing, and the second surgery stage is composed of vii) transplanting a stimulating device and viii) programming the stimulating device. The stages i) and ii) are preparation stages before the surgery, and the surgery is performed on an operating table from the stage iii).

First, the hair is removed. At this time, a cutter is used, and the operating surgeon takes a specific hand motion due to the use of the cutter. The sensing unit senses the hand motion for removing the hair (at this time, the cutter may be additionally sensed to collect information), and the determining unit may determine this as a hair removal motion pattern. An incision portion is marked on a region where the air is removed by the cutter, and in this case, a specific hand motion pattern for drawing lines on the skin of the cranium by a pen is exhibited. In addition, the cranium is incised along the lines marked by a pen by using a scalpel, and then the cranium is perforated by using a drill.

The hand motion behavior shows a specific pattern according to the feature of each behavior. If each pattern is defined in the motion pattern storing unit, the present hand motion data recognized through a surgery hand motion recognition interface is received in the format converted according to the data converting unit. By doing so, the motion predicting unit compares the hand motion information received by the hand motion information obtaining unit with the patterns defined in the motion pattern storing unit and recognizes this as a specific hand motion pattern.

The above process corresponds to a method of recognizing a hand motion corresponding to the present time point. In addition, the surgery stage predicting unit receives hand motion pattern information about a hand motion of each time point in real time and determines a progress stage of the overall surgery procedure. Based on the input of the user or the initial surgery motion pattern, an expected path of the surgery progress stage may be roughly searched.

In this example, first, the information about each behavior such as hair removal, marking of an incision portion, incision using a scalpel, and perforation of the cranium is received in order. In addition, the overall individual surgery procedures about all kinds of surgeries (here, the DBS surgery) are flexibly defined in the knowledge model for each stage in consideration of all situations which may happen during the surgeries. The surgery stage predicting unit infers a progress stage of the surgery procedure based on the hand motion information and the knowledge defined in the surgery procedure knowledge model. For example, if a situation of presently marking an incision portion is recognized, it is possible to know a present stage in the surgery procedure and a remaining time till the termination of the surgery, and it is also possible to refer that a next hand motion is incision using a scalpel. Therefore, the recognition ratio of hand motion patterns may be enhanced.

The embodiments described in the specification may be implemented as hardware entirely, hardware partially and software partially, or software entirely. In the specification, the term “unit”, “module”, “device”, “system” or the like indicates a computer-related entity like hardware, a combination of hardware and software, or software. For example, the term “unit”, “module”, “device”, “system” or the like used in the specification may be a process, a processor, an object, an executable file, a thread of execution, a program, and/or a computer, without being limited thereto. For example, both a computer and an application executed in the computer may correspond to the term “unit”, “module”, “device”, “system” or the like in the specification.

The method for predicting a surgery stage according to the embodiments of the present disclosure has been described with reference to the flowchart shown in the figure. For brief explanation, the method has been illustrated and described as a series of blocks, but the present disclosure is not limited to the order of the blocks. In other words, some blocks may be executed simultaneously with other blocks or in a different order from those illustrated and described in this specification, and various diverges, flow paths, block sequences may also be implemented if they give the equivalent or similar results. In addition, in order to implement the method described in the specification, it is also possible not to demand all blocks. Furthermore, the method for predicting a surgery stage may be implemented in the form of a computer program for executing a series of processes, and the computer program may also be recorded on a computer-readable recording medium.

Though the present disclosure has been described with reference to the embodiments depicted in the drawings, it is just an example, and it should be understood by those skilled in the art that various modifications and equivalents can be made from the disclosure. However, such modifications should be regarded as being within the scope of the present disclosure. Therefore, the true scope of the present disclosure should be defined by the appended claims.

What is claimed is:

1. A system for predicting a surgery progress stage, comprising:
a surgery motion sensing unit for sensing a surgery motion pattern;
a data storing unit for storing surgery stage information according to the kind of surgery and motion pattern information about principle major surgery motions of each surgery stage;
a surgery motion pattern determining unit for determining a present surgery motion pattern corresponding to the sensed surgery motion pattern, from the motion pattern information stored in the data storing unit; and
a surgery stage predicting unit for predicting a surgery stage corresponding to the determined present surgery motion pattern, based on the surgery stage information stored in the data storing unit.

2. The system for predicting a surgery progress stage according to claim 1, wherein the surgery motion pattern is a hand motion pattern and/or a motion pattern of a surgical instrument.

3. The system for predicting a surgery progress stage according to claim 1, wherein the surgery motion sensing unit includes:
a sensor for sensing a surgery motion image; and
a data converting unit for patterning the sensed surgery motion image to be converted into a predefined data format.

4. The system for predicting a surgery progress stage according to claim 1, wherein the surgery motion pattern determining unit includes a sub-pattern determining unit for storing a surgery motion pattern of a previous stage in the data storing unit and determining the present surgery motion pattern, based on the stored surgery motion pattern of the previous stage.

5. The system for predicting a surgery progress stage according to claim 1, further comprising a surgery stage display unit for displaying the predicted surgery stage to be provided to a user.

6. A method for predicting a surgery progress stage, comprising:
sensing a surgery motion pattern;
determining a present surgery motion pattern corresponding to the sensed surgery motion pattern, from major surgery motion pattern information stored in advance; and
predicting a surgery stage corresponding to the determined present surgery motion pattern, based on surgery stage information according to the kind of surgery stored in advance.

7. The method for predicting a surgery progress stage according to claim 6, wherein the surgery motion pattern is a hand motion pattern and/or a motion pattern of a surgical instrument.

8. The method for predicting a surgery progress stage according to claim 6, wherein said sensing of a surgery motion pattern includes:
sensing a surgery motion; and
patterning the sensed surgery motion to be converted into a predefined data format.

9. The method for predicting a surgery progress stage according to claim 6, further comprising:
storing surgery motion patterns of a previous stage and a present stage in a database,
wherein said determining of a present surgery motion pattern includes determining the present surgery motion pattern among the major surgery motion pattern information, based on the stored surgery motion pattern of the previous stage and the surgery stage information according to the kind of surgery stored in advance.

10. The method for predicting a surgery progress stage according to claim 7, further comprising:
providing the predicted surgery stage to a user by using a display device or a sound device.
